(19) United States
(12) Patent Application Publication
(10) Pub. No.: US 2012/0028657 A1
(43) Pub. Date: Feb. 2, 2012

(54) Efficient Paging for Multiple Universal Subscriber Identity Module (USIM) Equipment in TD-SCDMA Systems

(76) Inventors: Tom Chin, San Diego, CA (US); Guangming Shi, San Diego, CA (US); Kuo-Chun Lee, San Diego, CA (US)

(21) Appl. No.: 12/964,551

(22) Filed: Dec. 9, 2010

Related U.S. Application Data
(60) Provisional application No. 61/368,184, filed on Jul. 27, 2010.

(51) Int. Cl. H04W 68/00

(52) U.S. Cl. 455/458

(57) ABSTRACT

Wireless communication in a radio access network may be implemented when a user equipment (UE) is in active communication with a serving node B using a first international mobile subscriber identity (IMSI) and a communication request is made for a second IMSI associated with the same UE. The communication request to the second IMSI of the UE is directly through the serving node B rather than through a general page from the cells of the UE's location area or routing area. The direct communication may be through a page from the serving node B or through a unicast communication directly to the UE from the serving node B.

### CROSS REFERENCE TO RELATED APPLICATION

This application claims the benefit of U.S. provisional patent application No. 61/368,184 filed Jul. 27, 2010, in the names of CHIN et al., the disclosure of which is expressly incorporated herein by reference in its entirety.

### BACKGROUND

1. Field

Aspects of the present disclosure relate generally to wireless communication systems, and more particularly, to efficient paging of multiple Universal Subscriber Identity Module (USIM) user equipment in time division-synchronous code division multiple access (TD-SCDMA) systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

### SUMMARY

In one aspect of the disclosure, a method of wireless communication includes communicating with a serving node B (NB) during a call using a first international mobile subscriber identity (IMSI) of a user equipment (UE). The method also includes receiving a unicast message from the serving NB for a second call for a second IMSI of the UE.

In another aspect of the disclosure, a method of wireless communication includes communicating from a location area and/or a routing area to a UE during a call associated with a first international mobile subscriber identity. The method also includes transmitting a message only from a serving node B of the location area and/or routing area to the UE for a second call associated with a second IMSI of the UE.

In another aspect of the disclosure, a system is configured for wireless communication in a multicarrier radio access network. The system comprises means for communicating from a location area and/or a routing area to a user equipment during a call associated with a first international mobile subscriber identity. The system also includes means for transmitting a message only from a serving node B of the location area and/or the routing area to the UE for a second call associated with a second IMSI of the UE.

In another aspect of the disclosure, a computer program product includes a computer-readable medium having program code recorded thereon. The program code includes code to communicate from a location area and/or a routing area to a user equipment during a call associated with a first international mobile subscriber identity. The program code also includes code to transmit a message only from a serving node B of the location area and/or the routing area to the UE for a second call associated with a second IMSI of the UE.

In another aspect of the disclosure, a network controller for wireless communication includes at least one processor and a memory coupled to the processor. The processor is configured to communicate from a location area and/or a routing area to a user equipment during a call associated with a first international mobile subscriber identity. The processor is also configured to transmit a message only from a serving node B of the location area and/or the routing area to the UE for a second call associated with a second IMSI of the UE.

In another aspect of the disclosure, a user equipment (UE) is configured for wireless communication in a multicarrier radio access network. The UE has means for communicating with a serving node B (NB) during a call using a first international mobile subscriber identity (IMSI) of the UE. The UE also has means for receiving a unicast message from the serving NB for a second call for a second IMSI of the UE.

In another aspect of the disclosure, a computer program product includes a computer-readable medium having program code recorded thereon. The program code includes code to communicate with a serving node B during a call using a first international mobile subscriber identity of a user equipment. The program code also includes code to receive a unicast message from the serving NB for a second call for a second IMSI of the UE.

In another aspect of the disclosure, a user equipment for wireless communication includes at least one processor and a memory coupled to the processor. The processor is configured to communicate with a serving node B during a call using a first international mobile subscriber identity of the UE. The processor is also configured to receive a unicast message from the serving NB for a second call for a second IMSI of the UE.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a block diagram illustrating TD-SCDMA paging.

FIG. 5 is a diagram illustrating location areas and routing areas in a TD-SCDMA network.

FIG. 6A is a diagram showing conventional paging of a user equipment.

FIG. 6B is a diagram showing enhanced paging of a user equipment according to one aspect of the present disclosure.

FIG. 7 is a diagram illustrating UE data stored by a network according to one aspect of the present disclosure.

FIG. 8 is a call flow diagram illustrating enhanced paging of a user equipment according to one aspect of the present disclosure.

FIG. 9 is a flow diagram illustrating enhanced paging of a user equipment according to one aspect of the present disclosure.

FIG. 10 is a flow diagram illustrating enhanced paging of a user equipment according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

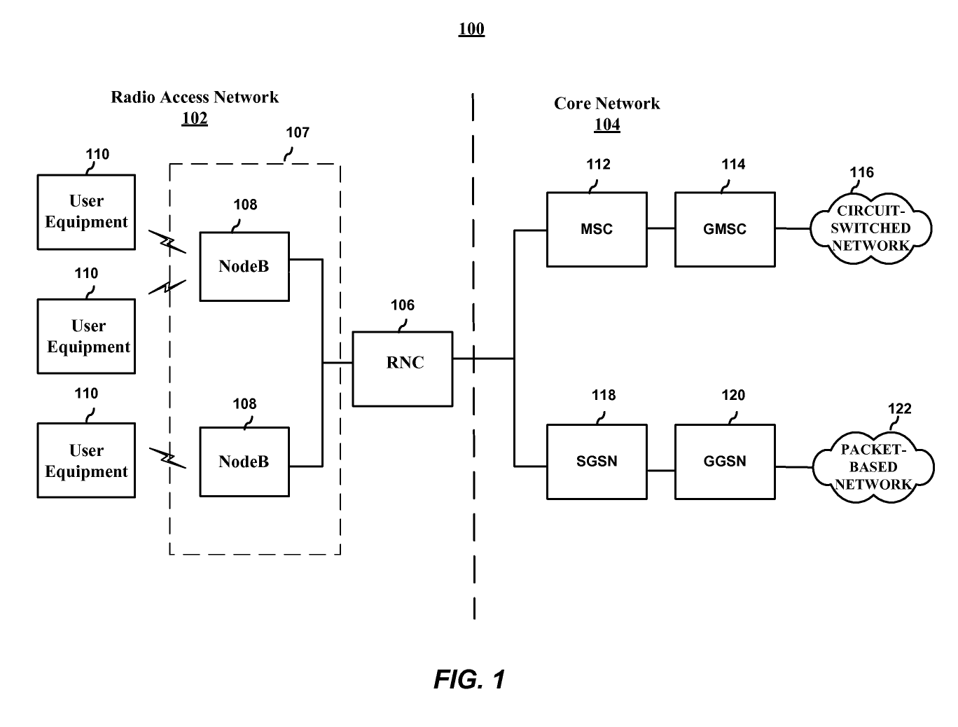

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs), such as an RNS 107, each controlled by a Radio Network Controller (RNC), such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces, such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

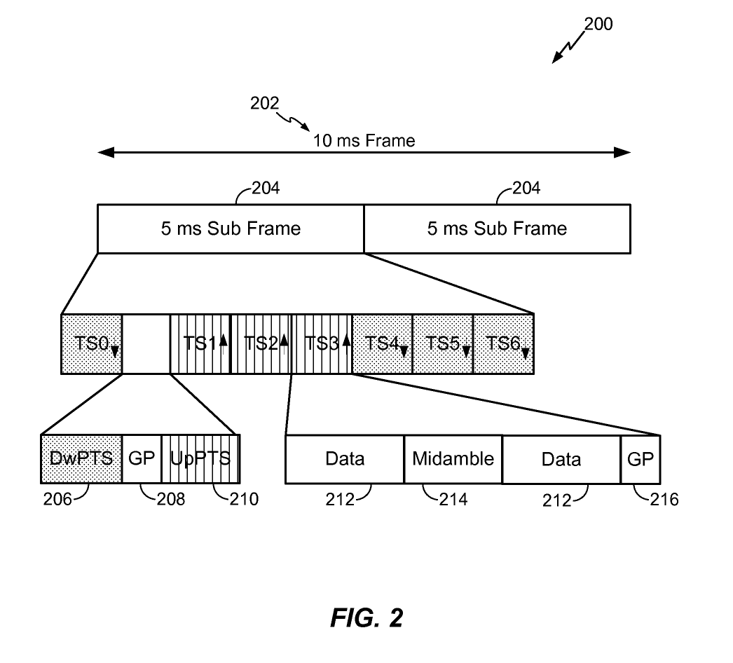

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

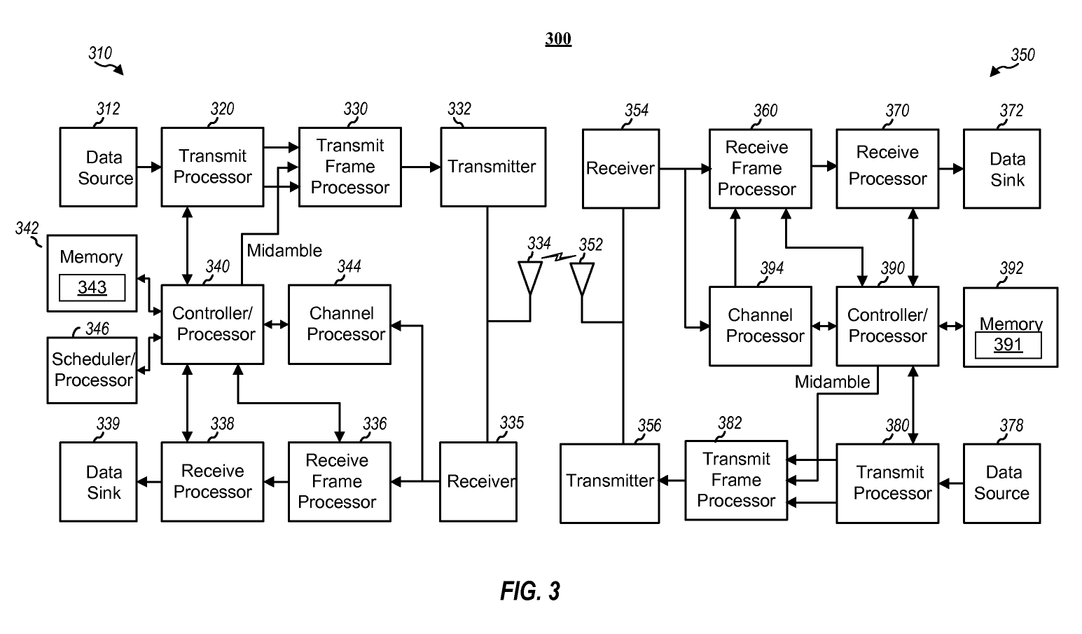

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard, pointing device, track wheel, and the like). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the smart antennas 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor 340, respectively. If some of the frames were unsuccessfully decoded by the receive processor 338, the controller/processor 340 may also use an acknowledgement (ACK) and/or negative acknowledgement (NACK) protocol to support retransmission requests for those frames.

The controller/processors 340 and 390 may be used to direct the operation at the node

B 310 and the UE 350, respectively. For example, the controller/processors 340 and 390 may provide various functions including timing, peripheral interfaces, voltage regulation, power management, and other control functions. The computer readable media of memories 342 and 392 may store data and software for the node B 310 and the UE 350, respectively. For example, the memory 392 of the UE 350 may store a multiple Universal Subscriber Identity Module (USIM) paging module 391 that, when executed by the controller/processor 390, allows the UE 350 to receive unicast paging messages for one of its International Mobile Subscriber Identities (IMSIs) when in active communication with the node B 310 using another of the UE's IMSIs. Similarly, the memory 342 of the node B 310 may store a direct paging module 343 that, when executed by the controller/processor 340, configures the node B 310 to identify if a desired IMSI is associated with an International Mobile Equipment Identity (IMEI) and UE that is in active communication, and execute a communication (either unicast or broadcast) to the desired IMSI through the other IMSI of the UE. A scheduler/processor 346 at the node B 310 may allocate resources to the UEs and schedule downlink and/or uplink transmissions for the UEs.

The network may also utilize hardware or software which implements an IMSI matching module that determines if a desired IMSI is associated with an IMEI and UE in active communication with a serving node B using a different IMSI. The matching module may then direct a communication for the desired IMSI directly to the serving node B. Although the present disclosure is described with respect to IMSI, IMEI, and USIM, alternatives could also be substituted for each.

In TD-SCDMA, the UE in idle mode monitors a recurrent paging interval to receive paging messages. When a Core Network (CN) receives a mobile terminated call, the TD-SCDMA Radio Network Controller (RNC) issues a paging request to a set of node Bs (NBs) to page the UE. The paging message may include the following information:
The UE identity. This may include the UE's international mobile subscriber identity (IMSI), the UE's Temporary Mobile Subscriber Identity (TMSI), or the user's Packet Temporary Mobile Subscriber Identity (P-TMSI).
The core network domain for the paging, either Circuit-Switched (CS) or Packet-Switched (PS).
The paging cause. Examples of paging causes include, but are not limited to, Terminating Conversational Call, Terminating Streaming Call, Terminating Interactive Call, Terminating Background Call, Terminating High Priority Signaling, and Terminating Low Priority Signaling.

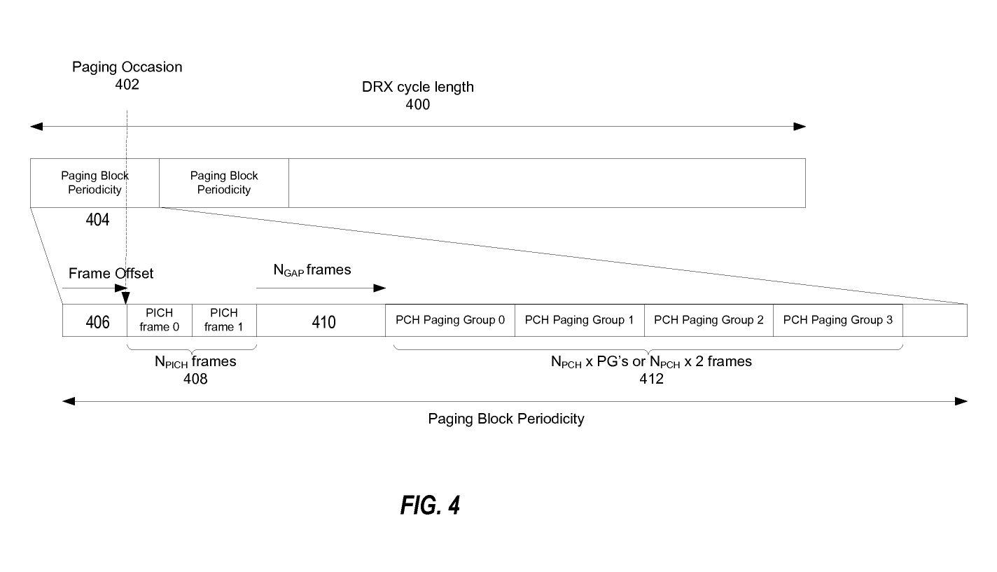

In TD-SCDMA networks, to reduce power consumption in idle mode, a UE conventionally uses Discontinuous Reception (DRX) to monitor for paging messages at recurring paging intervals. To do so, the UE monitors the paging occasion during the DRX cycle on the Paging Indicator Channel (PICH) and the Paging Channel (PCH). FIG. 4 is a block diagram illustrating a TD-SCDMA paging occasion 402 within a DRX cycle length 400. The Paging Block 404 begins with a frame offset 406, then includes Paging Indicator Channel frames 408, gap frames, 410, and Paging Channel frames 412. The DRX cycle length is determined by a circuit switched core network in the System Information message or can be negotiated between the packet switched core network and the UE. The UE starts to listen to the PICH starting with the associated paging_occasion, given by the following formula:

paging_occasion=(IMSI div K) mod (DRX_cycle div PBP)*PBP+frame_offset+j*DRX_cycle+p

The Paging Block Periodicity (PBP) is the number of frames between two paging blocks and frame_offset is frame offset of the first frame in the PBP, given in the System Information message. K is the number of Secondary Common Control Physical Channels (S-CCPCHs) that can carry the Paging Channel (PCH).

Each TD-SCDMA cell belongs to a Location Area (LA) and a Routing Area (RA). Location area is used for the Circuit-Switched (CS) domain and RA is used for the Packet-Switched (PS) domain. A location area can consist of a few cells and a routing area can consist of a few cells. Conventionally, one location area covers a larger area than one routing area. An RNC can request that node Bs in one or more location areas send paging messages for mobile terminated circuit switched call setup. Similarly, the RNC can request that node Bs in one or more routing areas send paging messages for mobile terminated packet switched call setup. When the network pages a particular UE, the paging signal is sent to the most recent location area and/or routing area in which the UE was known to have been located.

In order for the network to know the proper location area to page, the UE performs location area updating (LAU) procedures when the UE moves to a cell in a new location area different from the one in which the UE previously performed a location area update. Similarly, in order for the network to know which routing area to page, the UE performs routing area update (RAU) procedures when the UE moves to a cell in a new routing area different from the one in which the UE previously performed a RAU.

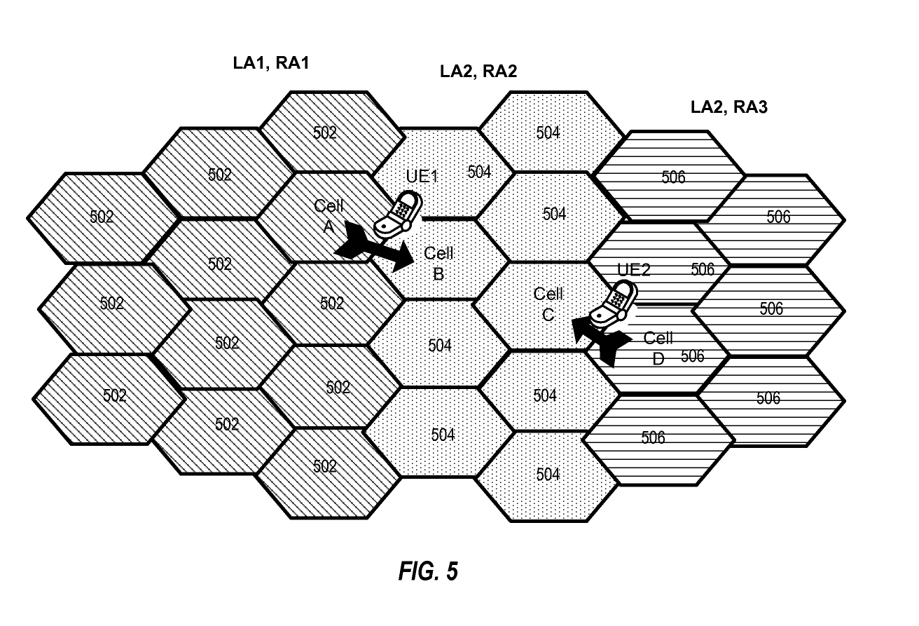

FIG. 5 is a diagram illustrating location areas and routing areas in a TD-SCDMA network. Particular cells (represented by the hexagonal spaces) may transmit for one location area and one routing area. However the borders for a location area and routing area may differ. A particular location area may intersect with one or more routing areas and a particular routing area may intersect with one or more location areas. In this example, three routing areas and two location areas are shown. The leftmost cells 502 belong to LA1 and RA1, the middle cells 504 belong to LA2 and RA2, and the right most cells 506 belong to LA2 and RA3. When UE1 moves from cell A in LA1, RA1 to cell B in LA2, RA2, then UE1 performs both location area update and routing area update procedures. When UE2 moves from Cell D in LA2, RA3 to Cell C in LA2, RA2, then UE 2 performs a routing area update procedure.

After the respective LAU and RAU updates described above, if the network sets up a mobile terminated circuit switched call to UE1 in its new location in Cell B (within LA2), then the RNC pages all the LA2 cells 504 and 506 (middle and rightmost cells). If the network sets up a mobile terminated packet switched call to the UE2 in its new location in Cell C (within RA2), then the RNC pages the RA2 cells 504. Paging can therefore consume substantial system bandwidth to broadcast paging messages in a particular location area or routing area.

In certain network systems, a mobile phone may have more than one Universal Subscriber Identity Module (USIM) which enables the user to make phone calls using different phone numbers from a single UE. Each USIM has a unique International Mobile Subscriber Identity (IMSI). If a first IMSI is engaged in a voice or packet call, the UE still monitors the paging messages of the second IMSI in case a call comes in destined for the second IMSI. Conventionally, the paging process for that second IMSI is the same as the process described above.

In general, paging is processing and bandwidth intensive because the RNC requests that several node Bs broadcast paging messages to ensure contact with the desired UE. To allow more efficient paging when the UE has already engaged in a call, an improved paging procedure is proposed.

If a UE with multiple USIMs has one IMSI already engaged in the call, the network only sends the paging message for the other IMSI from the cell currently serving the UE for the first IMSI, instead of from all the cells in the location area or routing area of the second IMSI. This arrangement saves significantly on processing and bandwidth.

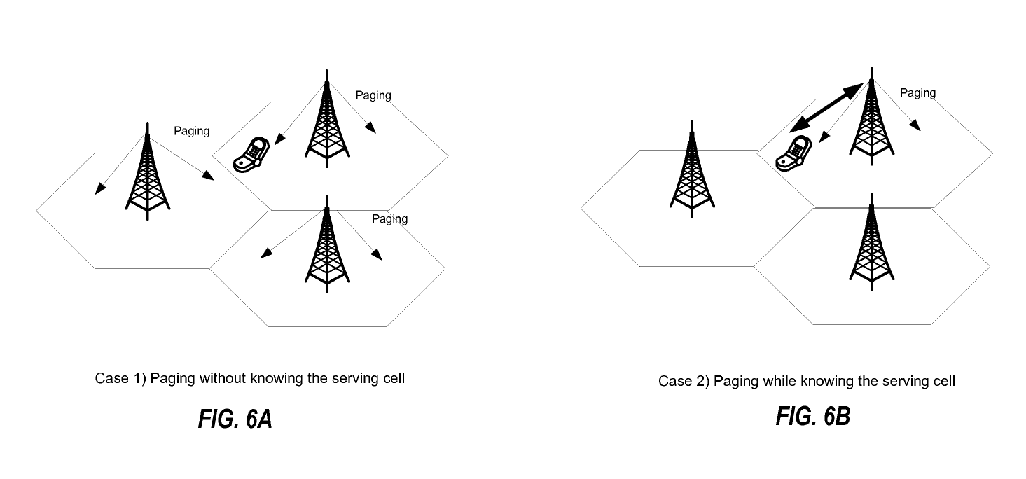

FIG. 6A illustrates conventional methods of broadcast paging, which occurs when the RNC pages from each cell in a location area or routing area. FIG. 6B illustrates the enhanced method of paging, which may be utilized when the network knows what cell is serving the UE on a different IMSI. This arrangement allows the network to utilize more precise location information when the UE is in the connected mode for one of its IMSIs. Communications from the serving cell to the UE may be either broadcast pages (represented by the two unidirectional arrows in FIG. 6B) or a direct unicast message to the UE (represented by the single bidirectional arrow in FIG. 6B).

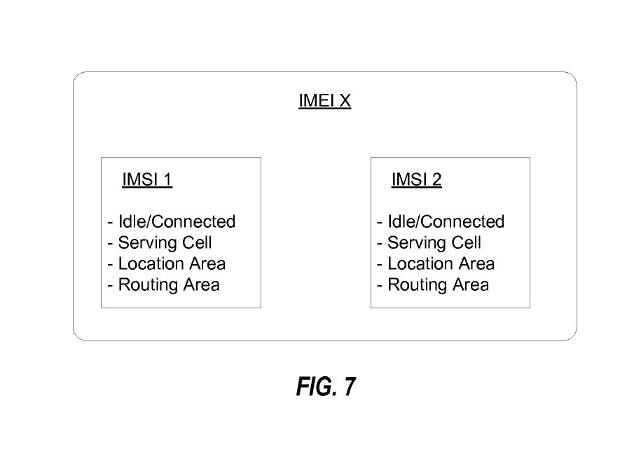

For the network to know that two IMSIs belong to the same UE, the network matches each IMSI with an International Mobile Equipment Identity (IMEI) which is unique to each UE. The network keeps track of the UE's IMSIs, state (e.g., idle or connected), and serving cell of the UE in connected mode. FIG. 7 is a diagram illustrating exemplary UE data stored by the network according to one aspect of the present disclosure. For each IMEI the network tracks which IMSI is associated with the IMEI. The network also tracks the UE state and serving cell. The network can also track the current location area and routing area. If a UE is in connected mode, the network can use the above information to identify the UE's cell if the need arises to page the non-connected IMSI of the UE. The network can then page the UE from the connected cell, rather than from every cell in the location area or routing area.

To further speed the delivery of paging messages, the network can send the paging message as a unicast message to the connected IMSI in connected mode. In this manner the network can avoid the need to wait for the next paging occasion to broadcast the paging message, and therefore reduce the delay of paging the IMSI.

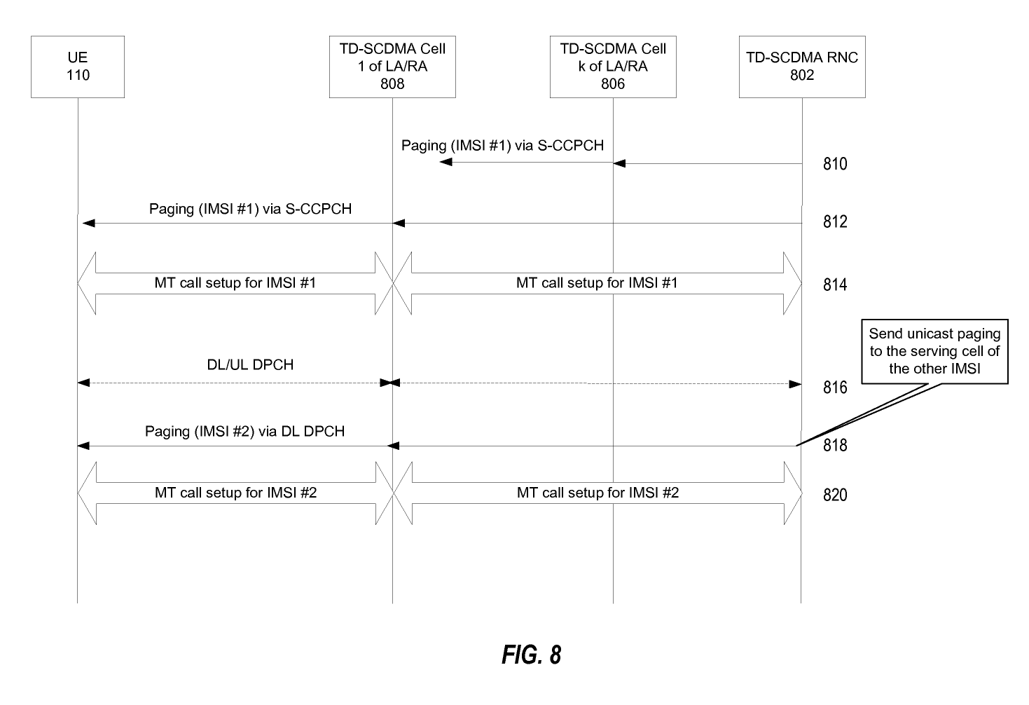

FIG. 8 is a call flow diagram illustrating enhanced paging of a user equipment according to one aspect of the present disclosure. A pictured UE 110 has two IMSIs, IMSI 1 and IMSI 2. When a first call is initiated for IMSI 1 at time 810 the RNC 802 sends a paging request via the S-CCPCH to the node Bs 806, 808 corresponding to the location area or routing area of the UE 110, that is each cell of the location area/routing area in which the UE is located (represented by Cells 1 and k of the location area/routing area). In FIG. 8, Cell 1 of the location area/routing area 808 is the cell in which the UE is located. As part of the general location area/routing area page, the paging signal is sent from Cell 1 808 to the UE 110 at time 812. Once the UE 110 receives the page for IMSI 1, it can exchange call setup messages with Cell 1, which exchanges call setup messages with the RNC 802, at time 814. Once the call is setup the UE and network may exchange downlink/uplink data via the Downlink Dedicated Physical Channel (DPCH) through Cell 1 808, at time 816.

The network then determines that it will page IMSI 2 of the UE 110. Because IMSI 1 is engaged in a call and the network knows that IMSI 2 and IMSI 1 share an IMEI, i.e., belong to the same UE, the network knows the cell that is connected to the UE associated with IMSI 2. With this information the network does not send a page to each cell in the location area/routing area of the UE. Instead, the network can send a unicast paging message directly to the serving cell of the location area/routing area, Cell 1 808. Thus, at time 818, the network pages IMSI 2 directly from Cell 1 808 using the downlink DPCH. Once the IMSI 2 page is received, at time 820 the UE 110 and RNC 802 can exchange call setup messages via Cell 1 808. Although the preceding description was with respect to a unicast message delivered at time 818, a broadcast message can be sent from the appropriate node B in another embodiment.

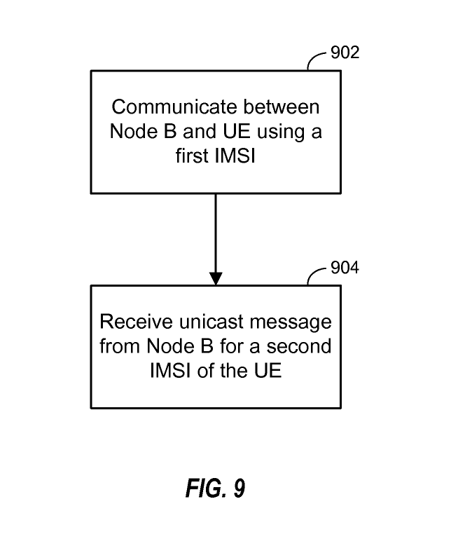

FIG. 9 is a flow diagram illustrating enhanced paging of a user equipment according to one aspect of the present disclosure. An apparatus, such as the UE 110 is configured to communicate with a node B using a first IMSI as shown in block 902. The UE is also configured to receive a unicast message for a second IMSI of the UE from the serving node B as shown in block 904.

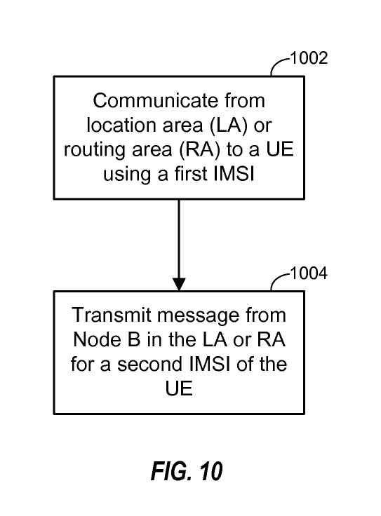

FIG. 10 is a flow diagram illustrating enhanced paging of a user equipment according to one aspect of the present disclosure. An apparatus, such as a node B 310 within a location area or routing area is configured to communicate with a UE 110 using a first IMSI as shown in block 1002. The node B is also configured to transmit a message for a second IMSI of the UE as shown in block 1004.

The present disclosure can allow paging messages sent to the serving cell using the connection for the other IMSI. It can save bandwidth and reduce delay of the paging procedure for a UE with multiple USIMs.

In one configuration, the apparatus, such as the node B 310, is configured for wireless communication and includes means for transmitting a message, which may be a unicast message or a broadcast message, for a second IMSI of a UE while communicating with the UE using a first IMSI of the UE. In one aspect, the aforementioned means may be the antennas 334, the transmitter 332, the transmit frame processor 330, the channel processor 344, the transmit processor 320, the controller/processor 340, and the memory 342 storing a direct paging module 343 all of which are configured together to perform the functions recited by the aforementioned means. In another aspect, the aforementioned means may be a module or any apparatus configured to perform the functions recited by the aforementioned means.

In one configuration, the apparatus, such as the UE 350, is configured for wireless communication and includes means for communication with a serving node B (NB) during a call using a first international mobile subscriber identity (IMSI) of a user equipment (UE); and means for receiving a unicast message from the serving NB for a second call for a second IMSI of the UE. In one aspect, the aforementioned means may be the antennas 352, the receiver 354, the receive frame processor 360, the channel processor 394, the receive processor 370, the controller/processor 390, and the memory 392 storing a multiple Universal Subscriber Identity Module (USIM) page module 391 all of which are configured together to perform the functions recited by the aforementioned means. In another aspect, the aforementioned means may be a module or any apparatus configured to perform the functions recited by the aforementioned means.

Several aspects of a telecommunications system have been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
communicating with a serving node B (NB) during a call using a first international mobile subscriber identity (IMSI) of a user equipment (UE); and
receiving a unicast message from the serving NB for a second call for a second IMSI of the UE.

2. The method of claim 1, in which the unicast message comprises a paging message.

3. The method of claim 1, in which the unicast message is received through a dedicated channel.

4. The method of claim 3, in which the dedicated channel comprises a Downlink Dedicated Physical Channel.

5. The method of claim 1, in which the unicast message is received through a common control channel.

6. The method of claim 5, in which the common control channel comprises a secondary common control physical channel.

7. A method of wireless communication, comprising:
communicating from at least one of a location area and a routing area to a UE during a call associated with a first international mobile subscriber identity (IMSI); and
transmitting a message only from a serving node B of the at least one of the location area and the routing area to the UE for a second call associated with a second IMSI of the UE.

8. The method of claim 7, further comprising determining that an International Mobile Equipment Identity (IMEI) associated with the first IMSI is also associated with the second IMSI.

9. The method of claim 7, in which the message comprises a paging message.

10. The method of claim 7, in which the message is transmitted through a dedicated channel.

11. The method of claim 10, in which the dedicated channel comprises a Downlink Dedicated Physical Channel.

12. The method of claim 7, in which the message is transmitted through a common control channel.

13. The method of claim 12, in which the common control channel comprises a secondary common control physical channel.

14. The method of claim 7, in which the message comprises a broadcast message.

15. The method of claim 7, in which the message comprises a unicast message.

16. A system configured for wireless communication in a multicarrier radio access network, the system comprising:
means for communicating from at least one of a location area and a routing area to a user equipment (UE) during a call associated with a first international mobile subscriber identity (IMSI); and
means for transmitting a message only from a serving node B of the at least one of the location area and the routing area to the UE for a second call associated with a second IMSI of the UE.

17. The system of claim 16, further comprising means for determining that an International Mobile Equipment Identity (IMEI) associated with the first IMSI is also associated with the second IMSI.

18. The system of claim 16, in which the message comprises a broadcast message.

19. The system of claim 16, in which the message comprises a unicast message.

20. A computer program product, comprising:
a computer-readable medium having program code recorded thereon, the program code comprising:
program code to communicate from at least one of a location area and a routing area to a user equipment (UE) during a call associated with a first international mobile subscriber identity (IMSI); and
program code to transmit a message only from a serving node B of the at least one of the location area and the routing area to the UE for a second call associated with a second IMSI of the UE.

21. The computer program product of claim 20, further comprising program code to determine that an International Mobile Equipment Identity (IMEI) associated with the first IMSI is also associated with the second IMSI.

22. The computer program product of claim 20, in which the message comprises a broadcast message.

23. The computer program product of claim 20, in which the message comprises a unicast message.

24. A network controller configured for wireless communication, the network controller comprising:
at least one processor; and
a memory coupled to the at least one processor, wherein the at least one processor is configured:
to communicate from at least one of a location area and a routing area to a user equipment (UE) during a call associated with a first international mobile subscriber identity (IMSI); and
to transmit a message only from a serving node B of the at least one of the location area and the routing area to the UE for a second call associated with a second IMSI of the UE.

25. The network controller of claim 24, wherein the processor is further configured to determine that an International Mobile Equipment Identity (IMEI) associated with the first IMSI is also associated with the second IMSI.

26. The network controller of claim 24, in which the message comprises a paging message.

27. The network controller of claim 24, in which the message is transmitted through a dedicated channel.

28. The network controller of claim 24, in which the message comprises a broadcast message.

29. The network controller of claim 24, in which the message comprises a unicast message.

30. A user equipment (UE) configured for wireless communication in a multicarrier radio access network, the UE comprising:
means for communicating with a serving node B during a call using a first international mobile subscriber identity (IMSI) of the UE; and
means for receiving a unicast message from the serving NB for a second call for a second IMSI of the UE.

31. The user equipment of claim 30, in which the unicast message comprises a paging message.

32. The user equipment of claim 30, in which the unicast message is received through a dedicated channel.

33. A computer program product, comprising:
a computer-readable medium having program code recorded thereon, the program code comprising:
program code to communicate with a serving node B during a call using a first international mobile subscriber identity (IMSI) of a user equipment (UE); and
program code to receive a unicast message from the serving NB for a second call for a second IMSI of the UE.

34. The computer program product of claim 33, in which the unicast message comprises a paging message.

35. The computer program product of claim 33, in which the unicast message is received through a dedicated channel.

36. A user equipment (UE) configured for wireless communication, the UE comprising:
at least one processor; and
a memory coupled to the at least one processor, wherein the at least one processor is configured:
to communicate with a serving node B during a call using a first international mobile subscriber identity (IMSI) of the UE; and
to receive a unicast message from the serving NB for a second call for a second IMSI of the UE.

37. The UE of claim 36, in which the unicast message comprises a paging message.

38. The UE of claim 36, in which the unicast message is received through a dedicated channel.
